(19) United States
(12) Patent Application Publication
(10) Pub. No.: US 2012/0069229 A1
(43) Pub. Date: Mar. 22, 2012

(54) UNIVERSAL IMAGE SENSOR CHIP INTERFACE

(75) Inventor: Scott L. TEWINKLE, Ontario, NY (US)

(73) Assignee: Xerox Corporation, Norwalk, CT (US)

(21) Appl. No.: 12/887,884

(22) Filed: Sep. 22, 2010

(51) Int. Cl. H04N 5/335

(52) U.S. Cl. 348/294; 348/E05.091

(57) ABSTRACT

An imaging system including at least one video channel having a plurality of imaging chips. Each imaging chip includes a command interpretation unit. The command interpretation unit includes a clock input, a data-in input and a data valid input. The clock input accepts a clock signal, the data-in input accepts a formatted bit sequence and the data valid input selectably causes the data-in input to accept the formatted bit sequence. The formatted bit sequence includes a class code and a function code. The command interpretation unit is adapted to interpret the formatted bit sequence and subsequently to output a control event based on the formatted bit sequence.

### INCORPORATION BY REFERENCE

The following co-pending applications are incorporated herein by reference in their entireties: U.S. patent application Ser. Nos. 11/143,173, filed on Jun. 2, 2005 and 11/950,508, filed on Dec. 5, 2007.

### TECHNICAL FIELD

The presently disclosed embodiments are directed to providing an image sensor array having a plurality of image sensor chips, and more particularly to providing a universal image sensor chip interface. The presently disclosed embodiments are also directed to a method of addressing video channels within an image sensor array and image sensing chips within the video channels.

### BACKGROUND

Several embodiments of control interfaces for image sensing chips within image sensor arrays are well known in the art, e.g., control interfaces for arrays comprising a plurality of image sensor chips where each sensor chip comprises a plurality of photosensitive pixels. An example of a known control interface consists of a master clock, i.e., (DS, six other inputs, i.e., ΦFR, ΦFB, ΦFG, SRI/OE, PCLK and DIN, and up to one output, i.e., SRO, depending on the type of video control, i.e., serial or parallel. ΦFR, ΦFB and ΦFG (or alternately IC, RS1 and RS0) are used for integration control, SRI/OE and SRO are used for video control, and PCLK and DIN are used for configuration control. The foregoing elements of an image sensor chip are described in Table 1 herebelow.

TABLE 1

| Label | Name | Description |
|---|---|---|
| ΦS | Pixel Clock | Determines the output data rate |
| ΦFR | Fence Clock | Controls integration time for RED row of |
| | | photodiodes in full-color or sub-sample |
| | | modes; Controls integration time for |
| | | MONO row of pixels in mono mode |
| ΦFB | Fence Clock | Controls integration time for BLUE row |
| | | of photodiodes in full-color or sub- |
| | | sample modes; Controls integration time |
| | | for MONO row of pixels in mono mode |
| ΦFG | Fence Clock | Controls integration time for GREEN row |
| | | of photodiodes in full-color or sub- |
| | | sample modes; Controls integration time |
| | | for MONO row of pixels in mono mode |
| SRI/OE | Shift Register In or | Activates the pixel readout; referred to |
| | Output Enable | as SRI when “serial” video control is |
| | | used; referred to as OE when “parallel” |
| | | video control is used; determines where |
| | | video is output |
| PCLK | Program Clock | Sets frequency for a program cycle |
| DIN | Program Data In | A 16-bit data stream that is encoded with |
| | | configuration information for the device; |
| | | synchronized to the rising edge of PCLK |
| SRO | Shift Register Out | With “serial” video control, SRO indicates |
| | | the device is about to end the pixel |
| | | readout; with “parallel” video control, |
| | | SRO is not used |

An example of the foregoing control interface is illustrated in FIG. 1A which depicts a full width array (FWA) 10 with serial video control and parallel programming. While FWA 10 does support either method of integration control, it only supports parallel programming, i.e., all sensor chips 12 on all video channels 14a-14d are configured the same, and cannot use serial programming, or in other words, each sensor chip can not be configured differently, unless the hardware is modified accordingly as shown in FIG. 1B. In FIG. 1B, it can be seen that all sensor chips 12 within each video channel 14a-14d may either be configured the same or different, since a unique Program Data In signal is provided for each video channel, e.g., DIN_{—}1, DIN_{—}2 . . . DIN_M.

The control interface of some known image sensor chips comprises eight inputs/outputs (I/O), where one subset of inputs performs integration time control, another subset performs video control and yet another subset performs configuration control. Furthermore, the known image sensor chips include two different methods of integration control, i.e., standard and Sim4R, two different methods of video control, i.e., serial—SRI/SRO and parallel—OE, and two methods of configuration control, i.e., serial and parallel, where such different methods of control are actuated by applying the control inputs in differing manners and/or via configuring the support hardware accordingly. This interface has evolved to the foregoing arrangement over time because of the desire to maintain backward compatibility; however, as a result it is not expandable since each type of control has its own I/O and it doesn't support all of the control methods simultaneously unless the support hardware is configured accordingly. These solutions result in increasing overhead for both the sensor chip and FWA.

As described in U.S. patent application Ser. No. 11/143,173, some image sensor chips utilize a software configurable interface. In this disclosure, the configurable interface combines three different control interfaces of an image sensor chip into the existing, i.e., at the time, configuration control interface in order to reduce the interface I/O and the associated full width array overhead. Although this device reduces the number of interface I/O, it still requires a program clock (PCLK) and LS clocks.

As described in U.S. patent application Ser. No. 11/950,508, some image sensor chips use a single wire programming interface. The disclosed device thus comprises a single wire programming interface for a FWA image sensor which uses both the integration control (parallel) and video control (serial) events to enable programming thereby reducing the configuration control to one input from four. The foregoing arrangement makes no change to the other control interfaces.

Moreover, some systems utilize serializer/deserializer pairs for the efficient transmission of control commands through a minimum number of data paths. A serializer/deserializer is a circuit that converts parallel data to serial data and vice-versa. Such circuits provide a convenient means for transmitting parallel data, e.g., control commands for a plurality of chips, between two locations over a serial connection. Thus, the total number of data paths between the two locations may be reduced, thereby reducing the number of physical connections between locations.

The present disclosure addresses a system and method for providing a control interface for an image sensor array that is based on formatted bit sequences. The present device includes an alternate method of providing serial and parallel programming to a FWA by uniquely identifying each sensor chip of the FWA by a channel and chip number and then using proper bit sequences to access and actuate the sensor chips through a universal interface. Furthermore, the present disclosure describes a method of address setting for the image sensor chips of an image sensor array. Moreover, the present disclosure describes a system having the ability to uniquely address and configure each image sensor array with the same interface.

### SUMMARY

Broadly, the apparatus discussed infra provides a compact and universal sensor chip interface that combines each of the control systems, i.e., integration time, video and configuration, into one interface and then implements such an interface with only three control inputs, i.e., CLK, DVAL and DIN. Operation of this interface is based on the application of formatted bit sequences to DIN whenever a control event is desired, where the format of the bit sequence determines the control event to actuate. The foregoing apparatus is compact because it requires only three inputs and is universal because all control events are actuated via the same interface. The present apparatus supports all current controls as well as being expandable, i.e., able to support several future controls without any hardware modifications or additional overhead.

The present imaging system apparatus includes at least one video channel having a plurality of imaging chips. Each imaging chip includes a command interpretation unit. The command interpretation unit includes a clock input, a data-in input and a data valid input. The clock input accepts a clock signal, the data-in input accepts a formatted bit sequence and the data valid input selectably causes the data-in input to accept the formatted bit sequence. The formatted bit sequence includes a class code and a function code. The command interpretation unit is adapted to interpret the formatted bit sequence and subsequently to output a control event based on the formatted bit sequence.

The present method for addressing a sensor chip within a video channel includes: a) forming a first binary sequence via a first set of wire bond connections; and, b) forming a second binary sequence via a second set of wire bond connections. The first binary sequence establishes an address for the video channel, while the second binary sequence establishes an address for the sensor chip within the video channel.

Other objects, features and advantages of one or more embodiments will be readily appreciable from the following detailed description and from the accompanying drawings and claims.

### BRIEF DESCRIPTION OF THE DRAWINGS

Various embodiments are disclosed, by way of example only, with reference to the accompanying drawings in which corresponding reference symbols indicate corresponding parts, in which:

FIG. 1A is a schematic diagram of a prior art image sensor array with serial video control and parallel programming;

FIG. 1B is a schematic diagram of a prior art image sensor array with serial video control and serial programming;

FIG. 2A is a schematic diagram of an embodiment of a present image sensor array having a universal control interface;

FIG. 2B is a schematic diagram showing a logical high bit and a schematic showing a logical low bit for use in the present method of identifying a video channel and a sensor chip;

FIG. 2C is an enlarged portion of FIG. 2A shown in encircled region 2C showing a single image sensor chip;

FIG. 2D is an enlarged portion of FIG. 2A showing a single image sensor chip arranged in a particular embodiment;

FIG. 3A is a table showing an embodiment the present formatted bit sequences which define various Classes and relevant control codes;

FIG. 3B is an embodiment of the structure of a Class A formatted bit sequence;

FIG. 3C is an embodiment of the structure of a Class B formatted bit sequence;

FIG. 3D is an embodiment of the structure of a Class C formatted bit sequence;

FIG. 3E is an embodiment of the structure of a Class D formatted bit sequence;

FIG. 4 is a schematic diagram of an embodiment of a command interpretation unit;

FIG. 5A is a table of an embodiment of a Class B control code;

FIG. 5B is a comparative signal diagram showing an embodiment of a Class B bit sequence and prior art controls;

FIG. 5C is a comparative signal diagram showing another embodiment of a Class B bit sequence and prior art controls;

FIG. 6A is a table of another embodiment of a Class B control code;

FIG. 6B is a comparative signal diagram showing another embodiment of a Class B bit sequence and prior art controls;

FIG. 7A is a table of an embodiment of a Class D control code; and,

FIG. 7B is a comparative signal diagram showing an embodiment of a Class D bit sequence and prior art controls.

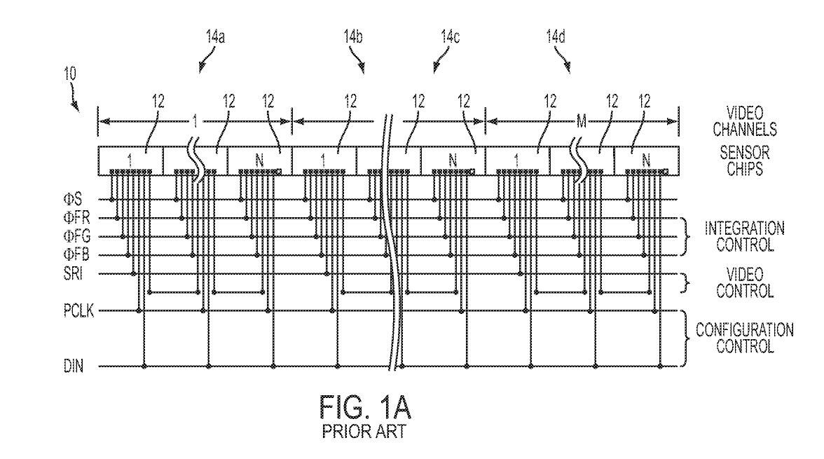

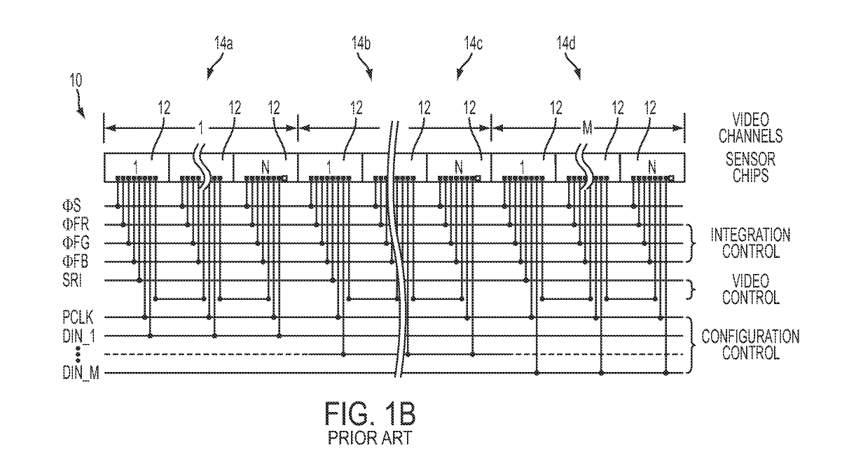

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As used herein, “image sensor array” may include but are not limited to: a collection of photosensor chips, e.g., a full width array. “Photosensor chip” or “imaging chip” is intended to be broadly construed as any collection of photosensitive pixels, e.g., a linear array of photodiodes. “Video channel” is intended to broadly mean a plurality of photosensor chips arranged in a logical grouping. Moreover, a “control event” is intended to broadly be construed as an instruction provided to a an image sensor array, photosensor chip or video channel, and may include instructions related to integration, video output or configuration. Furthermore, as used herein, “formatted bit sequence” is intended to mean a series of logical high/low values arranged to convey a particular set of instructions. A formatted bit sequence may also be referred to as a “binary sequence”.

Moreover, although any methods, devices or materials similar or equivalent to those described herein can be used in the practice or testing of these embodiments, some embodiments of methods, devices, and materials are now described.

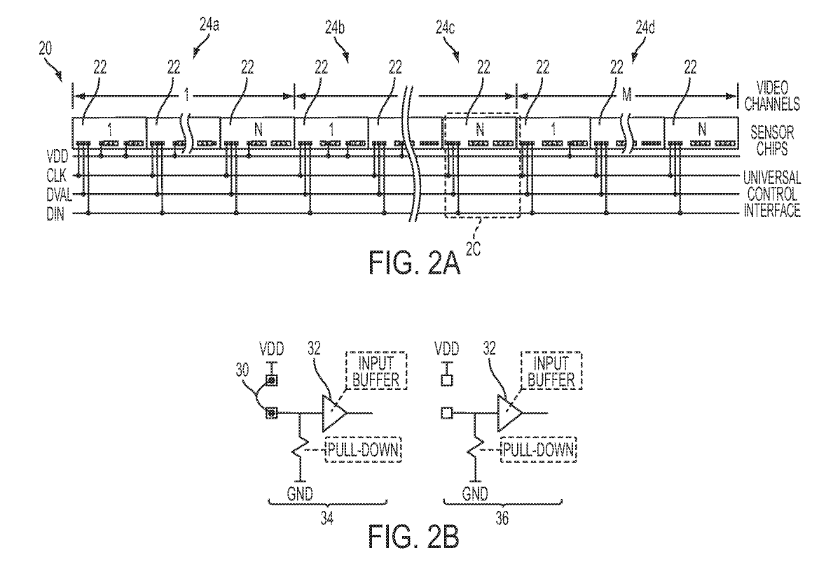

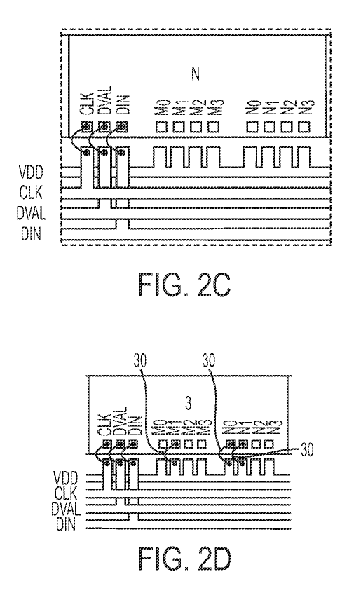

The present image sensor chip interface combines the three independent control interfaces of known image sensor chips, i.e., integration, video and configuration, into one universal interface that requires only three inputs, i.e., CLK (Master clock/Pixel clock), DVAL (Data valid) and DIN (Data in). It should be appreciated that VDD, i.e., a power supply, is also needed for the present image sensor chip interface to function, it is not discussed in greater detail as its function and arrangement are well known in the art. Furthermore, the present image sensor chip interface maintains the functionality of the prior art interfaces while being expandable for future needs. The foregoing is accomplished by creating a new interface that is based on formatted bit sequences which integrate a novel method of sensor chip addressing into its definition. The present interface reduces the number of control I/O by greater than 66% and the number of control I/O wire bonds by greater than 24%, while concurrently providing additional functionality when compared to known interfaces. FIG. 2A broadly represents how the present interface is applied to a typical FWA, i.e., FWA 20. As described above, FWA 20 includes image sensor chips 22 arranged within video channels 24a-24d. A comparison of a FWA which includes the present interface with respect to a FWA which includes a known interface is shown in Table 2 herebelow.

TABLE 2
Characteristics of a 20 Chip FWA with Serial Video Control

| | Sensor Chips | | Address | | |
|---|---|---|---|---|---|
| Video | per Video | | Wirebonds | | Control Wire |
| Channels | Channel | Control I/O | Channel | Chip | Bonds |
| 2 | 10 | 3 (66%↓) | 20 | 34 | 114(28%↓) |
| 4 | 5 | 3 (73%↓) | 25 | 28 | 113(29%↓) |
| 5 | 4 | 3 (75%↓) | 28 | 25 | 113(27%↓) |
| 10 | 2 | 3 (82%↓) | 34 | 20 | 114(24%↓) |

It should be appreciated that the desired speed of operation of the FWA is established by the number of video channels within the FWA. For example, a FWA having two video channels with ten sensor chips per channel will run slower than a FWA having ten video channels with two sensor chips per channel. Thus, depending on a user's needs, the number of video channels and sensor chips per channel may be varied, and such variations are within the spirit and scope of the claims.

CLK may be applied at the frequency that is ½X the desired output data rate, as is ΦS in the known interface. However, instead of applying a combination of fence clocks for integration control, a combination of SRI and SRO or OE for video control and a combination of PCLK and DIN for configuration control, with this present interface, each time a control event is required, DVAL is pulsed “high” and an appropriately formatted bit sequence is applied to DIN. It should be appreciated that although DVAL is pulsed “high” in the included examples, DVAL may also be pulsed “low” while a formatted bit sequence is applied to DIN, and such variations are within the spirit and scope of the claims. In view of the foregoing and as described infra, the three input lines CLK, DVAL and DIN provide a simple means for addressing each video channel and each sensor chip within each video channel discreetly.

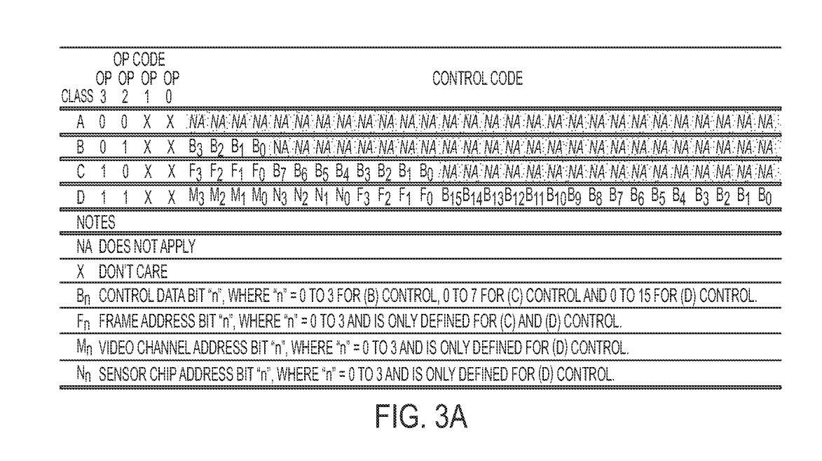

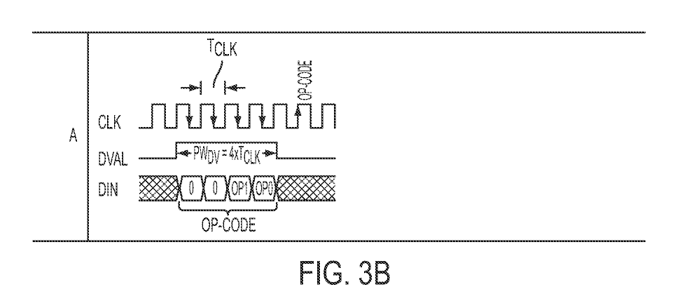

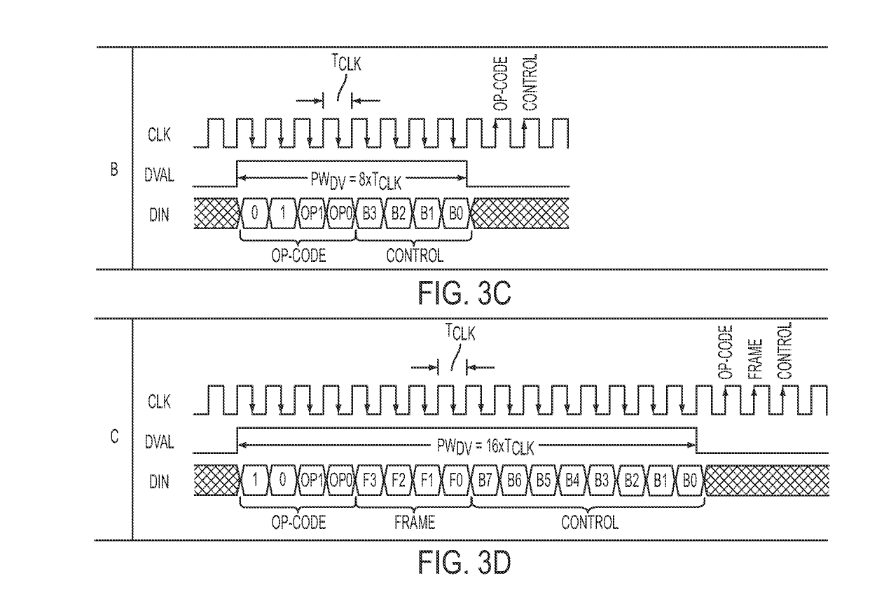

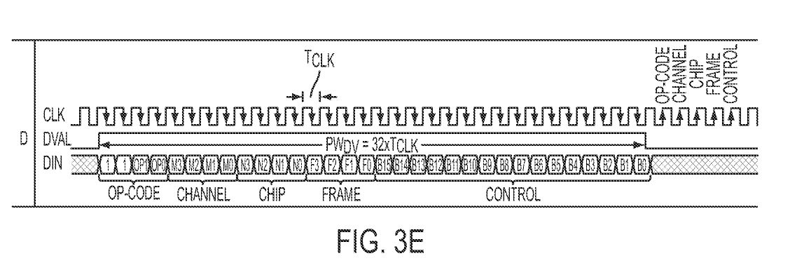

The first four bits of each formatted bit sequence are the OP code, i.e., OP3, OP2, OP1 and OP0, and such OP codes define the control event. The two most significant bits (MSB), i.e., OP3 and OP2, of the OP code identify the control class, i.e., “A”, “B”, “C” or “D”, while the two least significant bits (LSB), i.e., OP1 and OP0, define the control event to actuate. It should be appreciated that the most significant bits together form a class code, while the least significant bits together form a function code, and collectively the class and function codes form the OP code. With a 4-bit OP code, the present interface supports up to sixteen control events which is more than necessary in order to maintain the functionality of known image sensor arrays. The remaining bits of a formatted bit sequence are the control bits of which their format depends on the control class, i.e., Control Class “A” has no control bits, Control Class “B” has four control bits, Control Class “C” has twelve control bits and Control Class “D” has twenty eight control bits. Every control event is then actuated with a class specific delay after the falling edge of corresponding DVAL, as shown in FIGS. 3B through 3E.

Class “A” controls include control event that are applied to all the chips in parallel, e.g., applying a reset to the FWA to initialize on power up. Class “A” controls do not require any more control codes beyond 4-bits, i.e., OP3, OP2, OP1 and OP0. Class “B” controls include controls for lower level functions such as integration times. In other words, Class “B” controls include a 4-bit control code OP3, OP2, OP1 and OP0 as well as further control data codes B3, B2, B1 and B0 directed to, for example, the particular sensor to actuate, e.g., red, green or blue. Class “C” controls include, for each discreet function codes, sixteen different actions, i.e., defined by the 4-bit frame address code which includes F3, F2, F1 and F0, where each action has 256 levels of control, i.e., defined by the 8-bit control data code which includes B7, B6, B5, B4, B3, B2, B1 and B0. Class “D’ controls provide specific addressing such as, a channel address code (M3, M2, M1 and M0), a chip address code (N3, N2, N1 and N0), and further includes the frame address code (F3, F2, F1 and F0) and controls data code (B15, B14, B13, B12, B11, B10, B9, B8, B7, B6, B5, B4, B3, B2, B1 and B0). Collectively, the channel address code, chip address code, frame address code and control data code form a control code or control code sequence.

In view of the foregoing, it should be appreciated that the structure and length of the control code sequence is known based on what op code sequence is received. Moreover, for each class code, there are up to four discreet function codes or functions that may be defined, e.g., for a class code comprising OP3=“0” and OP2=“0”, OP1 and OP0 may have any one of the following functions 00, 01, 10 and 11. Still yet further, it must be appreciated that as the foregoing Classes and functions within Classes are defined by the formatted bit sequence received or accepted by DIN, additional Classes and functions within Classes may be included by changing the formatted bit sequence, e.g., a sequence including OP5, OP4 and OP3 defining the class code and OP2, OP1 and OP0 defining the function code within the particular Class. Similarly, any other portion of the overall control code may be modified based on a particular set of needs, for example, the number of channels on a chip may be increased beyond fifteen by adding an additional channel code such as M4. All of which modifications are within the spirit and scope of the claims.

To provide access uniquely to each video channel and each sensor chip within each video channel via the present interface, eight additional inputs to each sensor chip are included. Four of these inputs, i.e., M₃, M₂, M₁ and M₀, are defined to represent the video channel number while the remaining four inputs, i.e., N₃, N₂, N₁ and N₀, are defined to represent the sensor chip number within a video channel. Each of these addresses is defined for each image sensor chip in the FWA so that the combination of the eight inputs provides unique access to each chip. This addressing is implemented via wire bonding and as a result does not affect the number of control I/O, but only the number of wire bonds. To minimize the number of wire bonds only the “1's” or logical high values of an address need to be wire bonded because the address inputs are by default pulled to “0” or logical low values, as shown in FIG. 2B. Thus, when wire bond 30 is present, a voltage is present at input buffer 32 and a logical high value or “1” results. (See Schematic 34). Contrarily, when wire bond 30 is not present, no voltage is present at input buffer 32 and a logical low value or “0” results. (See Schematic 36). As a result, typically only 53 or 54 wire bonds are required instead of adding 140 wire bonds, as are typically used in the known image sensor arrays. The results in a net reduction of the total wire bonds by at least 24%.

An example of the foregoing wire bonds are shown in FIG. 2D. In this example, M₀, M₂ and M₃ are left unbonded to VDD, while M₁ is wire bonded to VDD. Thus, the binary address of the video channel associated with the image sensor chip shown in FIG. 2D is 0010, or in other words, video channel number 2. Moreover, N₂ and N₃ are left unbonded to VDD, while N₀ and N₁ are wire bonded to VDD. Thus, the binary address of the particular image sensor chip within video channel 2 is 0011, or in other words, sensor chip number 3. Hence, the sensor chip shown in FIG. 2D is sensor chip number 3 within video channel number 2.

This method of addressing was selected to be compatible with existing technology; however, improved methods may include eliminating the need for the address wire bonds. For example, one possible method is to use fuses that are “blown” after assembly of the FWA according to the desired configuration. This alternative eliminates the address wire bonds thereby reducing the total wire bonds of the FWA by at least an additional 38% from 113 or 114 wire bonds to 60 wire bonds.

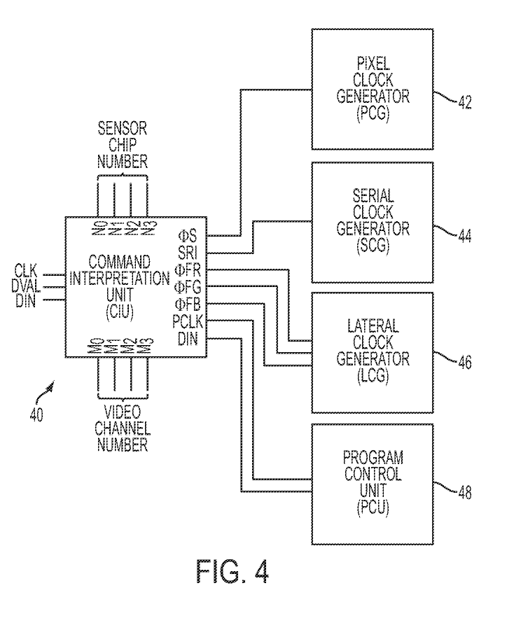

In some embodiments, the present interface also requires the development of a command interpretation unit (CIU). The CIU is added to each sensor chip and is designed to interpret the formatted bit sequences, and subsequently parse or output the proper event controls. An embodiment of a CIU is shown in FIG. 4. Thus, the formatted bit sequences set forth above are received by CIU 40 at inputs CLK, DVAL and DIN, and that sequence would then be combined with the bit sequence established by the 4-bit video channel address/number and the O-bit sensor chip address/number, to subsequently result in signals output to a pixel clock generator (ΦS), to a serial clock generator (SRI/OE), to a lateral clock generator (ΦFR, ΦFB and ΦFG), and to a program control unit (PCLK and DIN). Thus, the present universal image sensor chip interface may be combined with legacy image sensor arrays, while additionally being used in combination with future image sensor arrays. It should be appreciated that pixel clock generator 42 provides the clock cycle which is used by the discreet pixels, and it is only active when a video signal is present. Serial clock generator 44 creates the signals related to video, and it actuates each sensor chip within a channel in a serial fashion. Lateral clock generator 46 applies signals to all of the chips of a particular type, e.g., monochrome, red, green and blue, at the same time for purposes of integration, while program control unit 48 provides a control signal to a sensor chip for a particular event.

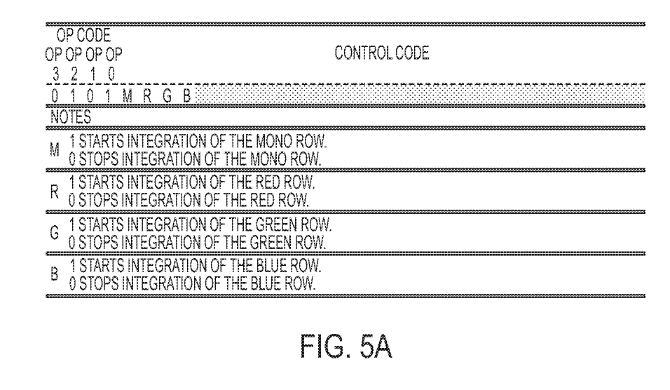

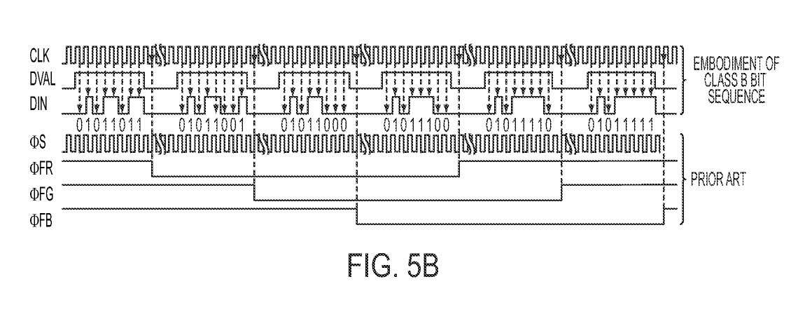

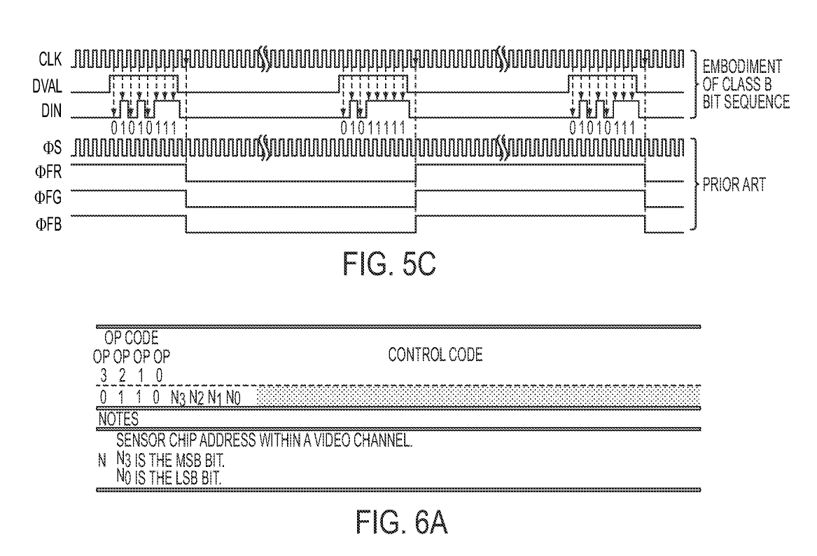

Various examples of uses of the present universal image sensor interface, including integration control, video control and serial programming of an FWA, are shown in FIGS. 5A through 7B. In the foregoing figures, the known interface techniques are included for comparison to the present universal image sensor interface, and such known interface techniques are labeled PRIOR ART.

FIGS. 5A through 5C depict an example of integration control. The table of FIG. 5A shows that integration control is a Class “B” operation having a function code of 01, or in other words, integration control is initiated by providing OP3=“0”, OP2=“1”, OP1=“0” and OP0=“1”. The remaining 4-bits of the control code define whether integration is started, i.e., control code=“1”, or integration is stopped, i.e., control code=“0”, for each of the monochrome, red, green and blue pixels.

FIG. 5B shows an example of three color integration control timing. Viewing the sequence from left to right, the first formatted bit sequence is 01011011, which indicates that the control code is related to integration, and that integration is started for the monochrome, green and blue pixels, while integration is stopped for the red pixels. The second formatted bit sequence is 01011001, which indicates that the control code is related to integration, and that integration is started for the monochrome and blue pixels, while integration is stopped for the red and green pixels. The third formatted bit sequence is 01011000, which indicates that the control code is related to integration, and that integration is started for the monochrome pixels, while integration is stopped for the red, green and blue pixels. The fourth formatted bit sequence is 01011100, which indicates that the control code is related to integration, and that integration is started for the monochrome and red pixels, while integration is stopped for the green and blue pixels. The fifth formatted bit sequence is 01011110, which indicates that the control code is related to integration, and that integration is started for the monochrome, red and green pixels, while integration is stopped for the blue pixels. The sixth formatted bit sequence is 01011111, which indicates that the control code is related to integration, and that integration is started for the monochrome, red, green and blue pixels. As can be clearly seen in this figure, the integration control information contained in the three signals of the prior art is effectively contained in a single formatted bit sequence in the present universal interface.

FIG. 5C shows an example of monochrome integration control timing. Viewing the sequence from left to right, the first formatted bit sequence is 01010111, which indicates that the control code is related to integration, and that integration is started for the red, green and blue pixels, while integration is stopped for the monochrome pixels. The second formatted bit sequence is 01011111, which indicates that the control code is related to integration, and that integration is started for the monochrome, red, green and blue pixels. The third formatted bit sequence is 01010111, which indicates that the control code is related to integration, and that integration is started for the red, green and blue pixels, while integration is stopped for the monochrome pixels. Again it can be clearly seen in this figure that the integration control information contained in the three signals of the prior art is effectively contained in a single formatted bit sequence in the present universal interface.

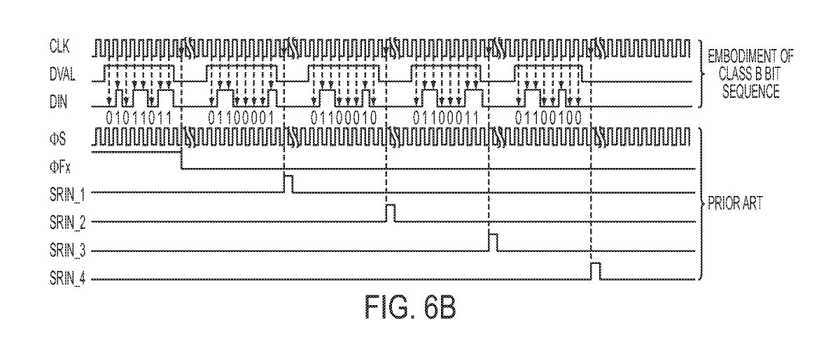

FIGS. 6A and 6B depict an example of video control. The table of FIG. 6A shows that video control is a Class “B” operation having a function code of 10, or in other words, video control is initiated by providing OP3=“0”, OP2=“1”, OP1=“1” and OP0=“0”. The remaining 4-bits of the control code define the sensor chip address within a video channel.

FIG. 6B shows an example of video control timing. Viewing the sequence from left to right, the first formatted bit sequence is 01011011, which indicates that the control code is related to integration, and that integration is started for the monochrome, green and blue pixels, while integration is stopped for the red pixels. The second formatted bit sequence is 01100001, which indicates that the control code is related to video, and that video data is started for the first sensor chip within the video channel. The third formatted bit sequence is 01100010, which indicates that the control code is related to video, and that video data is started for the second sensor chip within the video channel. The fourth formatted bit sequence is 01100011, which indicates that the control code is related to video, and that video data is started for the third sensor chip within the video channel. The fifth formatted bit sequence is 01100100, which indicates that the control code is related to video, and that video data is started for the fourth sensor chip within the video channel. As can be clearly seen in this figure, the video control information contained in the five signals of the prior art is effectively contained in a single formatted bit sequence in the present universal interface.

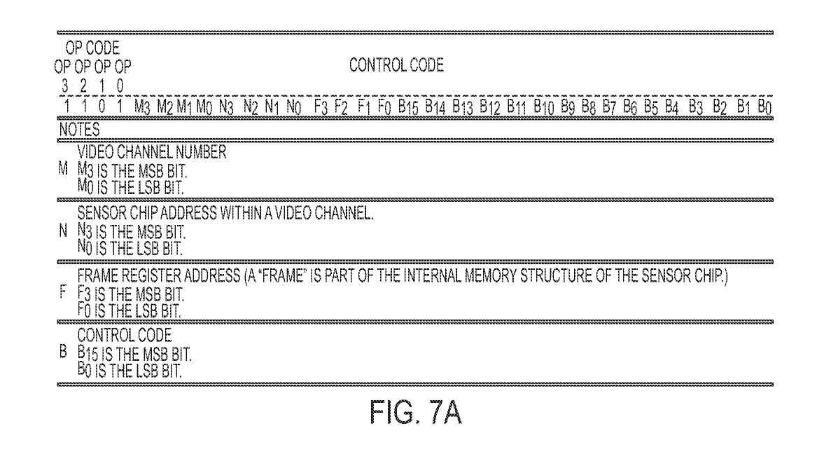

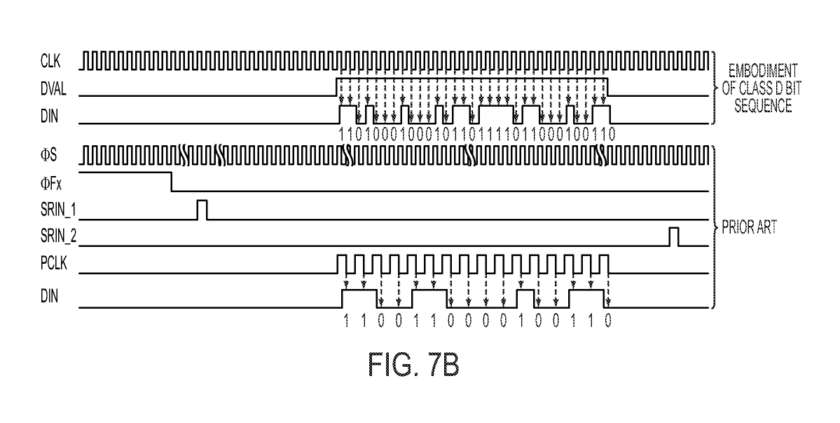

FIGS. 7A and 7B depict an example of serial configuration control. The table of FIG. 7A shows that serial configuration control is a Class “D” operation having a function code of 01, or in other words, serial configuration control is initiated by providing OP3=“1”, OP2=“1”, OP1=“0” and OP0=“1”. The remaining 28-bits of the control code define the video channel address, the sensor chip address within the video channel address, the frame register address and the control data code. This example shows how a single formatted bit sequence may be used to program a particular chip with its own unique configuration.

FIG. 7B shows an example of serial programming timing. Viewing the sequence from left to right, the formatted bit sequence is 11010001000101101111011000100110, which indicates that the control code is related to serial programming, and that control data code 1100110000100110 is applied to the sixth frame register, of the first sensor chip, of the first video channel. As can be clearly seen in this figure, the serial configuration control information contained in the five signals of the prior art is effectively contained in a single formatted bit sequence in the present universal interface.

As set forth in the embodiments herein, the present universal image sensor interface supports FWA configurations with 1 to 15 video channels having 1 to 15 sensor chips per video channel as each sensor chip is addressed with 4-bits. It should be appreciated that there are only 15 addressable sensor chips available because the “0” address is reserved for wafer level probing. These ranges accommodate most of the practical FWA applications but not all of them. To be compatible with more FWA configurations the number of address bits could be increased to 5-bits, for example. This would allow up to 31 video channels and 31 sensor chips per video channel. Although an increased number of video channels and sensor chips would be addressable, a tradeoff of adding two more address inputs would have to be made. It should be appreciated that changing the number of addresses only modifies the format of the DIN bit sequences without requiring further modification to the interface.

In view of the foregoing, it should be appreciated that the present universal image sensor array interface provides a control interface that is based on formatted bit sequences which in part provides the ability to uniquely address and configure each image sensor chip with the same interface. The same control interface may be used regardless of the image sensor array configuration, e.g., number of chips and number of video channels, and regardless of the type of desired control. Thus, the number of control I/O is effectively reduced by greater than 66% for a typical FWA. Moreover, a new means of address setting for image sensor chips on a FWA has also been set forth, i.e., using two 4-bit addresses defined by a particular arrangement of wire bonds or lack thereof. Hence, the number of wire bonds is reduced by greater than 24% for a typical FWA.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. An imaging system comprising:
at least one video channel comprising a plurality of imaging chips, each imaging chip comprising
a command interpretation unit comprising
a clock input, the clock input accepting a clock signal;
a data-in input, the data-in input accepting a formatted bit sequence, the formatted bit sequence comprising a class code and a function code; and,
a data valid input, the data valid input selectably causing the data-in input to accept the formatted bit sequence,
wherein the command interpretation unit is adapted to interpret the formatted bit sequence and subsequently to output a control event based on the formatted bit sequence.

2. The imaging system of claim 1 wherein the command interpretation unit further comprises a first address for the at least one video channel, the first address comprising at least one first wire bonded connection between the command interpretation unit and a power supply.

3. The imaging system of claim 2 wherein the first address comprises a 4-bit address.

4. The imaging system of claim 1 wherein the command interpretation unit further comprises a second address for the imaging chip of the plurality of imaging chips, the second address comprising at least one second wire bonded connection between the command interpretation unit and a power supply.

5. The imaging system of claim 4 wherein the second address comprises a 4-bit address.

6. The imaging system of claim 1 wherein the command interpretation unit further comprises a first address for the at least one video channel, the first address comprising at least one first wire bonded connection between the command interpretation unit and a power supply, a second address for the imaging chip of the plurality of imaging chips, the second address comprising at least one second wire bonded connection between the command interpretation unit and the power supply.

7. The imaging system of claim 6 wherein the first and second addresses each comprise a 4-bit address.

8. The imaging system of claim 1 wherein at one of the class code and the function code comprises a 2-bit value.

9. The imaging system of claim 1 wherein the formatted bit sequence further comprises at least one of: a channel address code; a chip address code; a frame address code; and, a control data code.

10. A method for addressing a sensor chip within a video channel, the method comprising:
a) forming a first binary sequence via a first set of wire bond connections, wherein the first binary sequence establishes an address for the video channel; and,
b) forming a second binary sequence via a second set of wire bond connections, wherein the second binary sequence establishes an address for the sensor chip within the video channel.

11. The method of claim 10 wherein the first binary sequence is a first 4-bit address.

12. The method of claim 10 wherein the second binary sequence is a second 4-bit address.

13. The method of claim 10 wherein the first set of wire bond connections and the second set of wire bond connections each comprise at least one wire bond between the sensor chip and a power supply.

14. The method of claim 10 wherein the first binary sequence is formed via the first set of wire bond connections and a first set of unbonded connections and the second binary sequence is formed via the second set of wire bond connections and a second set of unbonded connections.

15. The method of claim 14 wherein the first set of wire bond connections and the second set of wire bond connections result in a first set of logical high values and a second set results in a second set of logical high values, respectively, and the first set of unbonded connections and the second set of unbonded connections result in a first set of logical low values and a second set results in a second set of logical low values, respectively.
